(19) United States
(12) Patent Application Publication
(10) Pub. No.: US 2006/0263062 A1
(43) Pub. Date: Nov. 23, 2006

(54) Method of and apparatus for setting video signal delimiter information using silent portions

(75) Inventor: Yuki Takao, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/434,866

(22) Filed: May 17, 2006

(30) Foreign Application Priority Data
May 17, 2005 (JP) 2005-143788

(51) Int. Cl. H04N 7/00

(52) U.S. Cl. 386/96

(57) ABSTRACT

According to one embodiment, a method of taking in an output signal from an audio signal processing section and analyzing the state of the signal comprises determining a portion where the audio level is equal to or lower than a threshold value for a specific time in the output signal to be a silent portion, determining whether the time interval between the silent portion and the next silent portion is a multiple of a specific time (A), if the time interval is a multiple of the specific time (A), counting the number of times a silent portion is detected, and if the count of the silent portions is equal to or larger than a threshold value (B), setting delimiter information in the silent portion appearing at the beginning and the one appearing at the end.

### CROSS-REFERENCE TO RELATED APPLICATIONS

This application is based upon and claims the benefit of priority from Japanese Patent Application No. 2005-143788, filed May 17, 2005, the entire contents of which are incorporated herein by reference.

### BACKGROUND

1. Field

One embodiment of the invention relates to a method of and apparatus for setting video signal delimiter information using silent portions to achieve video structuring. That is, the method and apparatus are used in, for example, chapter-dividing video data and/or audio signals to structure images, while capturing the characteristics of video data and/or audio signals.

2. Description of the Related Art

In a television broadcasting signal, a commercial break is usually provided at the boundary between programs or in the middle of a program. An apparatus has been developed which detects the commercial portion and records the program together with the beginning and end position information on the commercial interval (refer to patent document 1). In addition, an apparatus has been developed which detects the commercial portion and the commercial portion is played at high speed when a program is reproduced. For example, refer to Jpn. Pat. Appln. KOKAI Publication No. 09-284706, Jpn. Pat. Appln. KOKAI Publication No. 08-235676, and Jpn. Pat. Appln. KOKAI Publication No. 2002-247516.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary basic configuration of an embodiment of the present invention;

FIG. 2 is an exemplary diagram to help explain the principle of main-story automatic chapter division according to the embodiment;

FIG. 3 is an exemplary flowchart to help explain a silent portion detecting block used in main-story automatic chapter division according to the embodiment;

FIG. 4 is an exemplary flowchart to help explain a commercial detecting operation used in main-story automatic chapter division according to the embodiment;

FIG. 5 is an exemplary flowchart to help explain a large block in the operation of main-story automatic chapter division according to the embodiment;

FIG. 6 shows a screen for setting the operation of main-story automatic chapter division according to the embodiment;

FIG. 7 is an exemplary diagram to help explain an example of another chapter division process similar to the operation of main-story automatic chapter division;

FIG. 8 is an exemplary diagram to help explain another example of another chapter division process similar to the operation of main-story automatic chapter division;

FIG. 9 shows a screen for setting the chapter division processes explained in FIGS. 7 and 8; and

FIG. 10 is an exemplary block diagram of a recording and reproducing apparatus to which the present invention has been applied.

### DETAILED DESCRIPTION

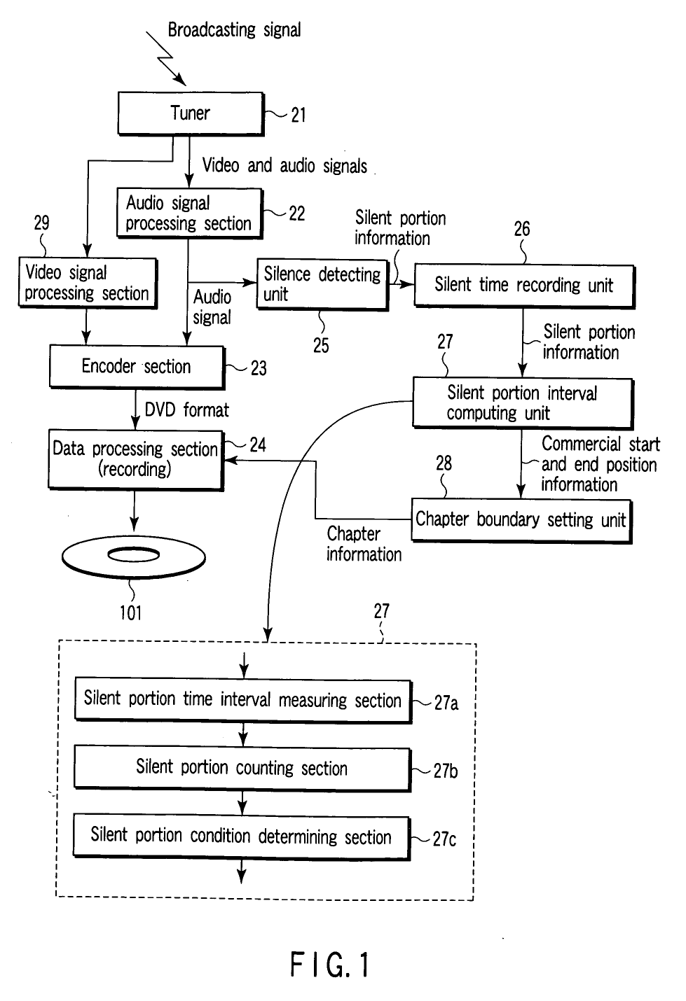

Various embodiments according to the invention will be described hereinafter with reference to the accompanying drawings. FIG. 1 shows the configuration of a flat-panel video display apparatus to which the present invention is applied.

An embodiment of the present invention provides a method of and apparatus for setting arbitrary intervals in a video signal in such a manner that, even when a silent portion has been detected, if the detected condition does not apply to a specific rule, the method and apparatus set no division information in the silent portion, thereby enabling a commercial interval to be detected exactly. In other words, the embodiment provides a method of and apparatus for setting video-signal delimiter information using silent portions which detect silent portions where the detected condition applies to a specific rule and then exactly detect a commercial interval with the silent portions as delimiters, thereby setting an arbitrary interval in the video signal.

In the embodiment, an audio signal is input and a portion where the audio-signal level is equal to or lower than a threshold value for a specific time is determined to be a silent portion. It is determined whether the time interval between a silent portion and the next silent portion is a multiple of a specific time (A). If the time interval is a multiple of a specific time (A), silent portions are counted. If the count of the silent portions is equal to or larger than a threshold value (B), chapter delimiter information is set in each of the silent portions appeared at the beginning and at the end.

As described above, in the embodiment, instead of setting delimiter information in all of the silent portions, delimiter information is set in the silent portions appeared at the beginning and at the end on condition that the interval between silent portions is a multiple of the specific time (A) and the count of silent portions in a cluster is equal to or larger than the threshold value (B). As a result, it is possible to delimit the audio signal suitably.

FIG. 1 shows a basic configuration of the embodiment of the present invention. In FIG. 1, a broadcasting signal is received at a tuner 21. The tuner 21 outputs the video and audio signals of a program on the selected channel. The audio signal is demodulated and decoded at an audio signal processing section 22. The output of the audio signal processing section 22 is supplied to an encoder 23 and a silence detecting unit 25 explained later.

On the basis of the DVD standard, the encoder section 23 encodes the video signal and audio signal into signals with specific formats and outputs the resulting signals to a data processing section 24. The data processing section 24 is capable of modulating and recording information onto a hard disk, DVD-R, DVD-RW, or DVD-RAM. Moreover, the data processing section 24 is capable of demodulating the information read from the disk. In addition, the data processing section 24 includes the function of processing an error correction code (ECC).

The output of the audio signal processing section 22 is also supplied to the silence detecting unit 25. The silence detecting unit 25 detects, as a silent portion, a part where the audio level is equal to or lower than a threshold value for a specific time. At this time, the silence detecting unit 25 outputs silence information to a silent time recording unit 26. That is, the silent time recording unit 26 accumulates silent portion information (or information on the time when a silent portion was determined) in the program.

The silent time information recorded in the silent time recording unit 26 is used at a silent portion interval computing unit 27. The silent portion interval computing unit 27 determines whether the time interval between a silent portion and the next silent portion is a multiple of a specific time (A). If the time interval is a multiple of the specific time (A), the silent portion interval computing section 27 counts silent portions. If the count of silent portions is equal to or larger than a threshold value (B), the silent portion interval computing section 27 sets chapter delimiter information in the silent portion appeared at the beginning as commercial start information and in the silent portion appeared at the end as commercial end information and supplies these pieces of information to a chapter boundary setting unit 28.

The chapter boundary setting unit 28 then creates chapter information and supplies the information to the data processing section 24. The data processing section 24 converts the chapter information into an entry point in management information complying with the DVD standard and manages the data.

Video information is processed at a video signal processing section 29 and is input to the encoder section 23, which converts the input signal into specific data conforming to the DVD standard. Then, the output of the encoder section 23 is recorded onto a recording medium (e.g., an optical disk) 101 via the data processing section 24. The recording medium may be not only an optical disk but also a semiconductor memory.

Here, the silent portion interval computing section 27 further includes a silent portion time interval measuring section 27a that determines whether the time interval between a silent portion and the next silent portion is a multiple of a specific time (A) in further dividing the interval into blocks, a silent portion counting section 27b that counts silent portions if the time interval is a multiple of the specific time (A), and a silent portion condition determining section 27c that sets delimiter information in the silent portions appeared at the beginning and at the end if the count of silent portions is equal to or larger than a threshold value (B).

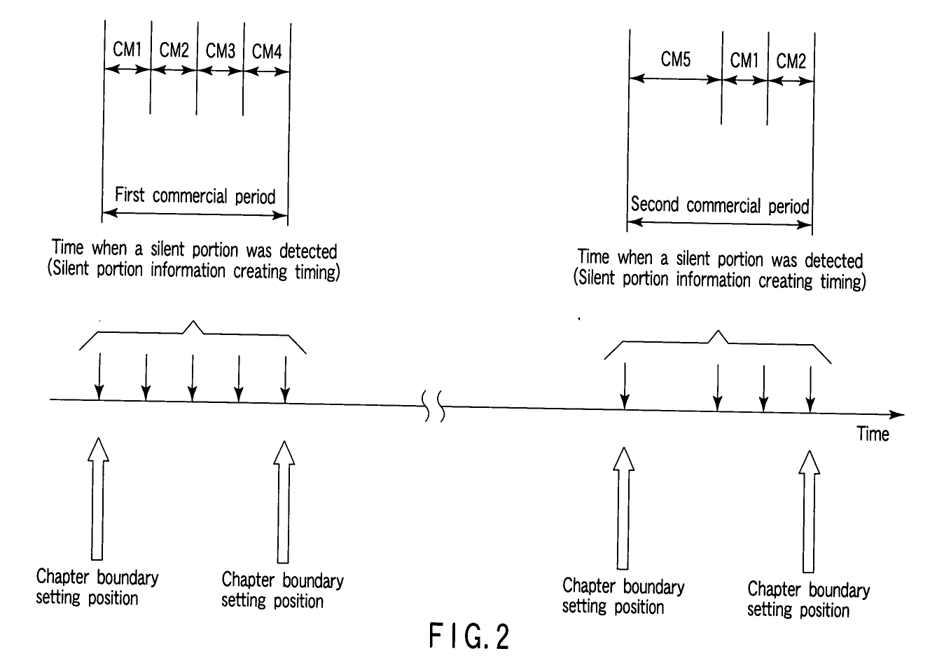

FIG. 2 shows on the time axis the time at which a silent portion was detected by the silence detecting unit 25, silent time storage unit 26, silent portion interval computing unit 27, and chapter boundary setting unit 28 and the time at which chapter information was obtained to set a chapter boundary. To make the explanation easer to understand, simplification is used. FIG. 2 shows a case where there are two commercial periods in one program (e.g., a program scheduled to be recorded).

Specifically, FIG. 2 shows a case where in a first commercial period, four commercials, CM1, CM2, CM3, and CM4, were broadcast, and in a second commercial period, three commercials, CM5, CM1, and CM2, were broadcast.

For example, in the first commercial period, since there are silent periods in the delimiter potions of each commercial, silent portion detecting flags are obtained. However, after CM4, since a condition explained later is not satisfied, the end of CM4 is determined to be a chapter boundary position. Moreover, the position of the silent portion detecting flag immediately before the start of the first CM1 is set as a chapter boundary. That is, flags indicating chapter boundaries are obtained before and after a commercial period. Similarly, in the second commercial period, too, chapter boundaries are not set in all of the silent portions, but a plurality of commercials (broadcast consecutively) satisfying a specific condition are grouped together and a chapter boundary is set using a group as a unit.

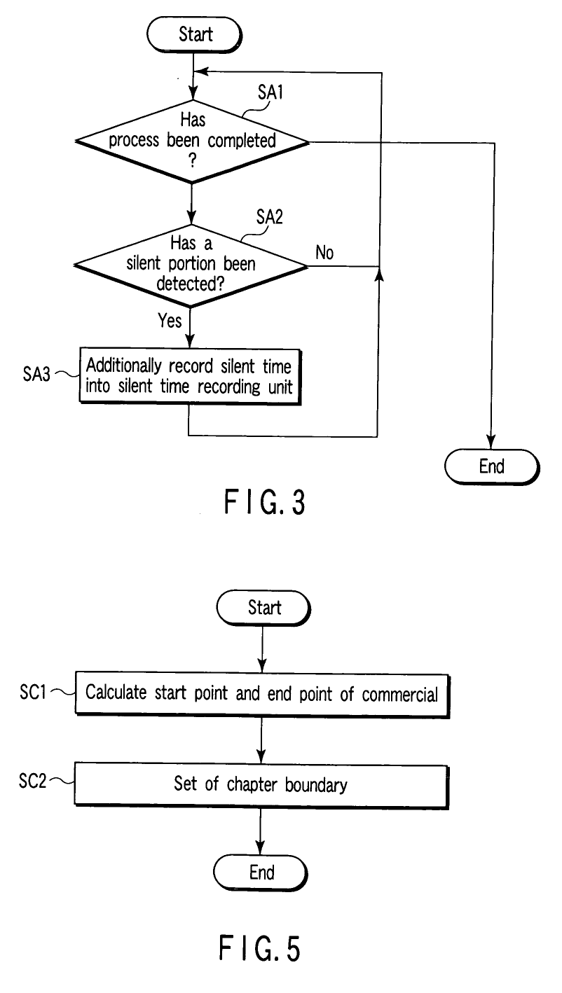

FIG. 3 shows the steps of carrying out the above processes in large blocks. It is determined whether the process of setting a chapter in one program has been completed (block SA1). If the process has not been completed, a silence detecting process is carried out to detect a silent portion (block SA2). If a silent portion has been detected, the time at which the silent portion was detected is stored as described above (block SA3). When management information is processed at the end of the program, a chapter boundary is set as an entry point in the management information as explained in FIG. 2.

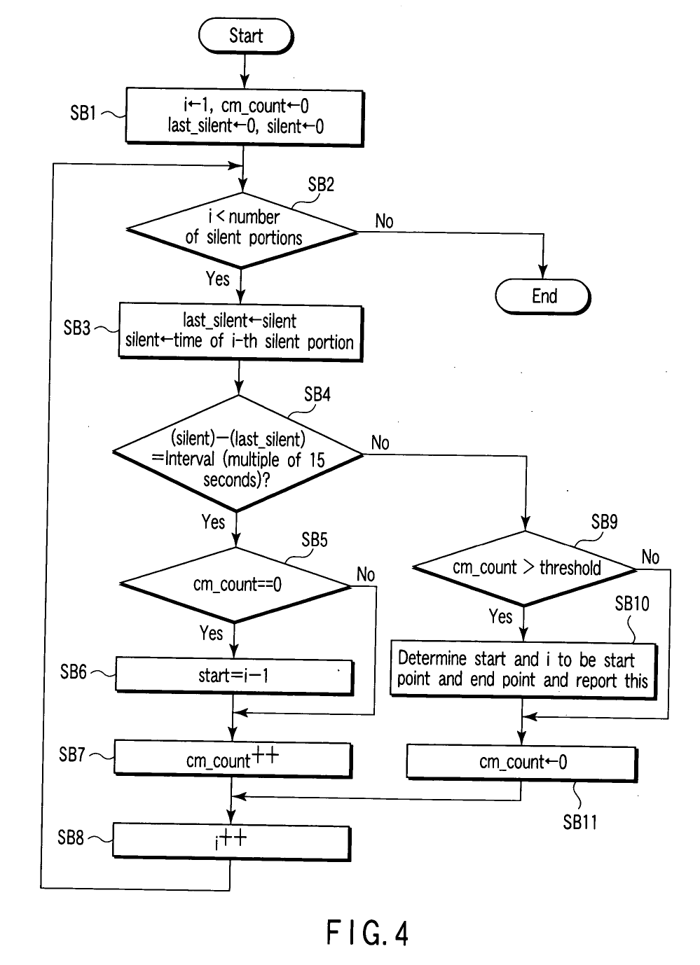

FIG. 4 is a flowchart to help explain the way a chapter boundary for the commercial start point and a chapter boundary for the commercial end point are determined when silent portions are detected one after another in a commercial period. After the process starts, when a silent portion is detected, i is used as information indicating a number in the order of silent portions. When the first silent portion is detected, then i←1, commercial count value (cm_count) is set as cm_count←0, the time of the last silent portion (last_silent) is set as last_silent←0, and the time at which a silent portion was detected is set as silent←0 (block SB1).

If the number of silent portions is smaller than i when a silent portion has been detected, the preceding time (silent) is set as last_silent←silent and the present time (silent) is determined to be the time of the i-th silent portion (blocks SB2, SB3). Next, (silent)−(last_silent) is calculated, thereby determining whether the value is a multiple of 15 seconds. The reason is that commercials are often broadcast in units of 15 seconds of in units of a multiple of 15 seconds.

It the value is 15 seconds (value A) or a multiple of 15 seconds, it is determined whether cm_count=0 is fulfilled (block SB5). If cm_count=0, It is immediately after the count of commercials is started. Since in block SB6, i−1 corresponds to the start time of a commercial, then start←i−1.

If in block SB5, cm_count≠0, this means that a commercial period has already started, control proceeds to block SB7, where cm_count is incremented by one. After block SB7, the process of (i+1) is carried out (block SB8) and control returns to block SB2.

In the preceding block SB4, the result of calculating (silent)−(last_silent) is not a multiple of 15 seconds (value A), it is regarded as not being a commercial period. At this time, control proceeds to block SB9, where it is determined whether cm_count accumulated up to now satisfies the expression cm_count>threshold value (B). If cm_count satisfies the expression, it is determined that a plurality of commercial groups have been broadcast. In this case, the start time and the time at which the present accumulated i was obtained are determined to be the commercial start point and the commercial end point respectively, which are then reported to the chapter boundary setting unit (block SB10). Thereafter, cm_count and i are set as cm_count=0 and i=0.

The specific time (value A) may be made variable. To make the value A variable, there is provided a special setting user guide menu. The threshold value (B) may have a specific margin.

FIG. 5 helps explain the operation of the chapter boundary setting unit 28. The flowchart of FIG. 5 shows the procedure for acquiring information on the commercial start point and the commercial end point (block SC1) and setting a chapter boundary (block SC2).

As described above, with the method and apparatus of the embodiment, all of the positions of the detected silent portions are not made chapter boundaries in a commercial broadcasting period, but the start position and end position of a plurality of consecutive commercials (consecutive commercial groups) are detected.

The user can set the turning on and off of the above function by selection. In this case, the user can select a detailed setting button on a program scheduling screen and further select the turning on and off, while looking at a detailed setting screen.

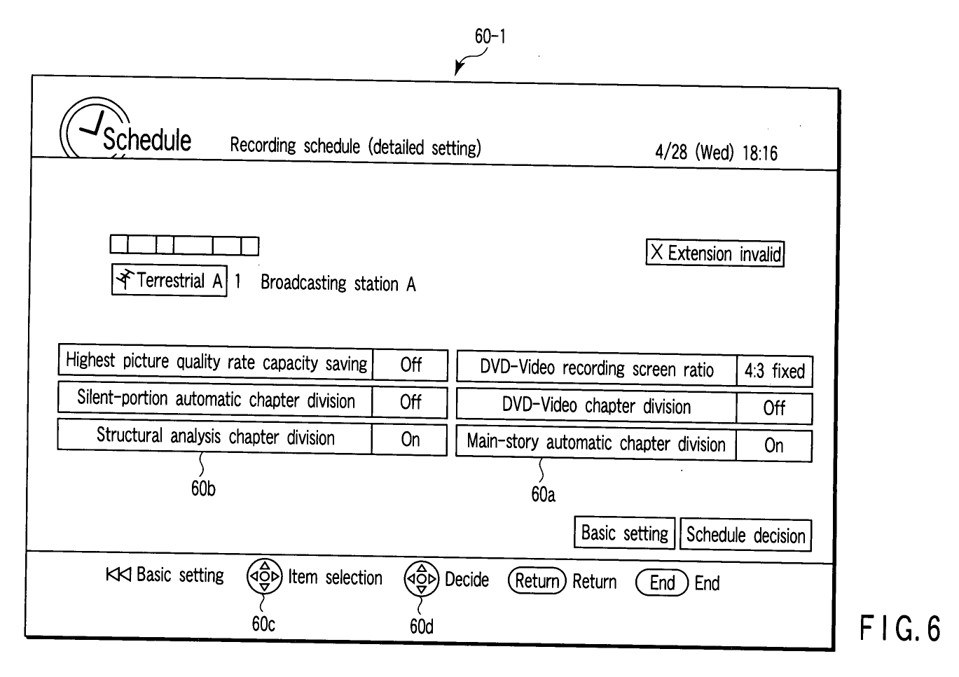

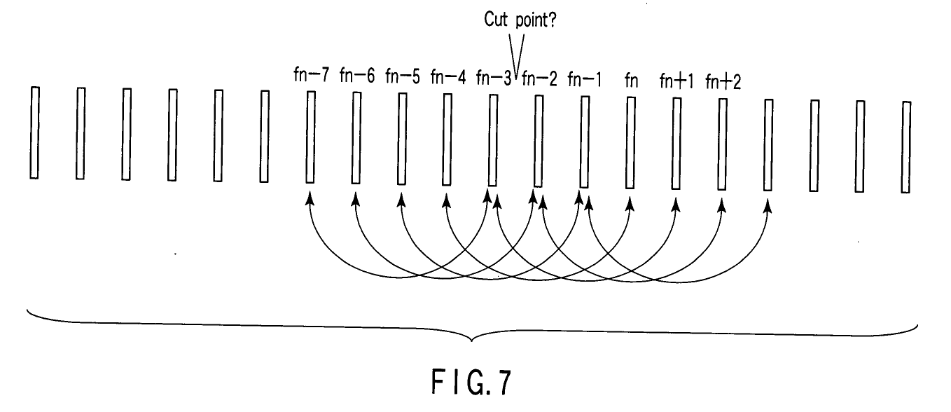

FIG. 6 is an example of a detailed setting screen 60 appearing when the user selects the “detailed setting” button on the scheduling screen to schedule the recording of one program and clicks the button. As shown in FIG. 6, the item “Main-story automatic chapter division” 60a is “On”. This state means that the aforementioned chapter division operation can be achieved. The user can switch between “On” and “Off” cyclically by putting the cursor on the item 60a by remote control and pressing the decision key.

Further on this screen 60, the item “Structural analysis chapter division” 60b is provided to make a structural analysis division of a video signal. The function based on “Structural analysis chapter division” differs from the aforementioned function (featuring an accurate detection of commercial periods) based on “Main-story automatic chapter division” in the chapter division process.

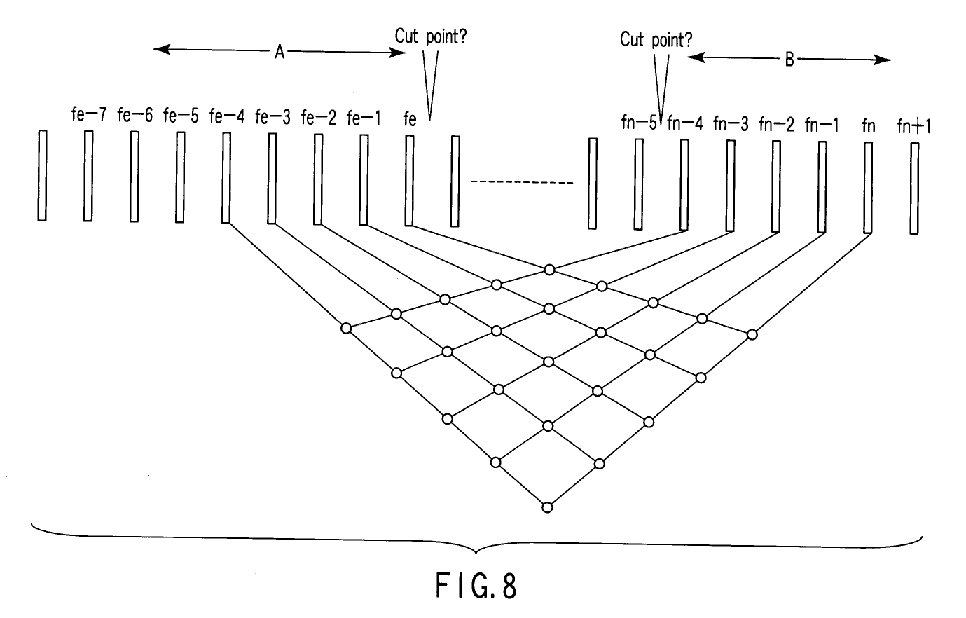

As shown in FIGS. 7 and 8, the function of making a structural analysis chapter division, such as the function based on “Structural analysis chapter division, is to analyze mostly video data and determine the similarities of fields or frames. It is a method of detecting cuts, determining similar shots, calculating the number of dialogs, and determining chapter boundaries. The spacing between cut points is called a shot.

In “detecting cuts”, an I picture and another I picture (or frames separated at intervals of 0.5 seconds) are compared with one another. If the hue of the entire screen differs greatly or the number of areas where brightness variation is great is larger than a preset parameter, the frames are determined to be dissimilar to one another. Then, frames separated at intervals of 0.5 seconds are compared with one another sequentially. If there is an interval where the number of groups of dissimilar frames is equal to or larger than a threshold value, a cut point is set at an arbitrary point in the interval. FIG. 7 shows the way the similarity between frames indicated by arrows is determined. In a part where there are many groups of dissimilar frames, a cut point is set. In FIG. 7, fn, fn−1, fn−2, . . . , fe, fe−1, fe−2, . . . indicate frames.

In “detecting similar shots”, the similarity between several frames going back from a past cut point and several frames after the most recent cut point is determined in a round-robin manner. Then, if the number of groups of frames determined to be “similar” is equal to or larger than a threshold value, the two shots are determined to be similar. That is, as shown in FIG. 8, it is determined whether the frames between shot A and shot D existing between a cut point and another cut point are similar to one another. In a combination of frames in FIG. 8, for example, there are as many similarity determinations as there are places marked with a circle.

“Detection of dialogs” and “the number of dialogs” are defined as follows. (a) An interval (or part) where similar shots appear intensively is a meaningful interval. (b) The index “the number of dialogs” is introduced to quantify the density at which similar shot appear. “The number of dialogs” becomes larger as the following conditions are satisfied: (b1) many shots are included (=cut points appear frequently); (b2) the number of shots contributing (=similar) to dialogues is large; and (b3) the total time of shots contributing (=similar) to dialogues is long.

On the basis of (c) the number of dialogues, a dialogue interval is calculated. Then, (d) adjacent dialogue intervals are connected to one another.

The “structural analysis chapter division” function is basically carried out by the above processes. When cut points are set and similar shots are detected, these may be realized sufficiently by the above processes. However, to add the function of restructuring a plurality of program structures, the following functions may be additionally included.

They are a “news-program-specific processing” function and an “other-programs processing” function.

The “news-program-specific processing” function is to suppose a similar shot distributed in a program to some extent, having some length, and appearing more than a certain number of times to be a “begin shot of the topic”. When “begin shots of the topic” are consecutive, the last one of the consecutive begin shots is determined to be a true “begin shot of the topic” and the others are determined to be a “follow-up for the preceding topic”. The “other-programs processing” function is to set a “corner title detecting” function. This function is to determine a similar shot distributed widely in a program, belonging to no dialog interval, and appearing more than a certain number of times to be a “corner title”. If no corner title appears even a while after the start of a program, the program is regarded as a “program with no corner title”.

As described above, if information on program cut points, information on similar shots, information on the beginning of the topic of a news program, and information on the corner titles of the other programs are obtained, when a program is edited or when the chapters for a program are structured, they can be used as useful information.

In the above example, on a screen 60-1 appearing when the detailed setting button is clicked on the recording scheduling screen, the item “Structural analysis chapter division” 60b appears. However, the item 60b for setting “Structural analysis chapter division” also appears by selecting a recording unit on the menu screen and then causing a screen for setting a recording function to appear.

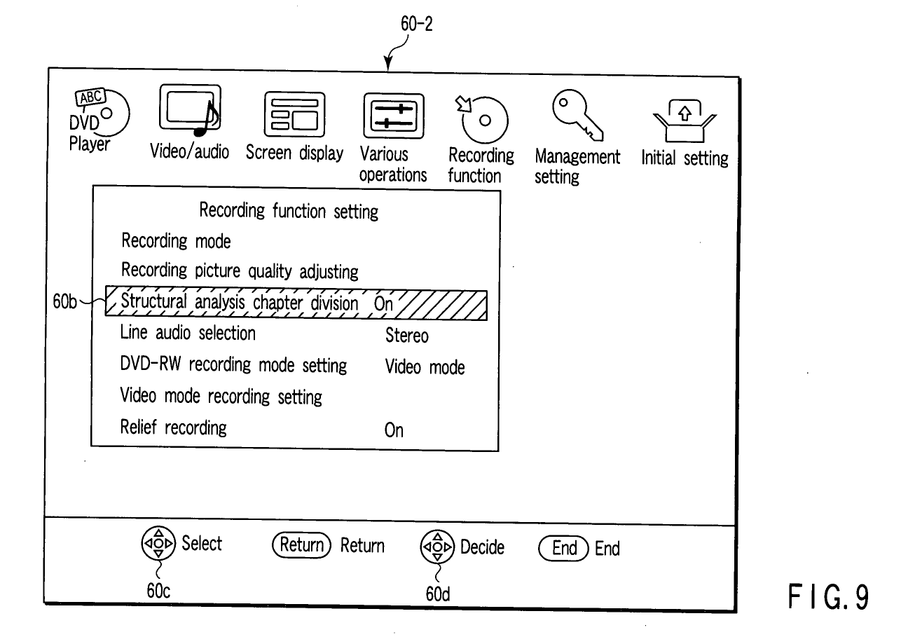

FIG. 9 shows a case where the item “Structural analysis chapter division” 60b appears on a screen 60-2 for setting a recording function. On this screen, too, the item 60b for determining whether to make “structural analysis chapter division” appears.

On the aforementioned screens 60-1, 60-2, the mark for the operation section of the remote controller is displayed. Specifically, the mark of a cursor key for moving the cursor upward, downward, rightward, and leftward and the mark of a decision key are displayed. These are useful keys in guiding the user's operation.

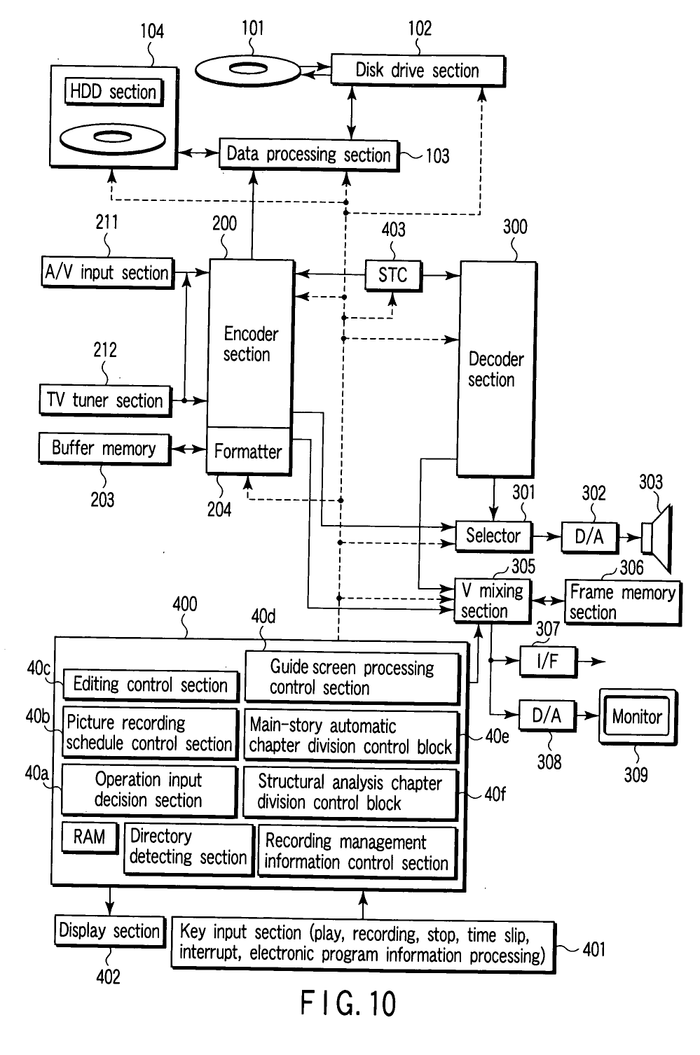

FIG. 10 shows an overall configuration of a recording and reproducing apparatus to which the present invention has been applied. The recording and reproducing apparatus has two types of disk drive sections. An optical disk 101 is an information recording medium in which a video file can be structured. A disk drive section 102 rotates the optical disk 101, thereby reading and writing information. Numeral 104 indicates a hard disk drive (HDD) section which drives a hard disk.

The data processor section 103 can not only supply recording data to the disk drive section 102 and hard disk drive section 104 but also receive a reproduced signal. The disk drive section 102 includes a rotation control system for the optical disk 101, a laser driving system, and an optical system.

The data processor 103, which deals with data in recording or reproducing units, includes a buffer circuit, a modulation/demodulation circuit, and an error correction section.

The recording and reproducing apparatus is mainly composed of an encoder section 200 that constitutes the recording system side, a decoder section 300 that constitutes the reproducing system side, and a microcomputer block 400 that supervises control of the operation of the overall apparatus. The encoder section 200 includes a video and audio analog-to-digital converter that digitizes an input analog video signal and an analog audio signal, a video encoder, and an audio encoder. The encoder section 200 further includes a sub-video encoder that compresses subtitles or the like.

The output of the encoder section 200 is converted into a specific DVD (such as, DVD-R, DVD-RW, or DVD-RAM) format at a formatter 204 including a buffer memory 203, which supplies the resulting signal to the data processor 103. An AV input section 211 inputs an external analog video signal and an external analog audio signal to the encoder section 200. Alternatively, a TV tuner 212 inputs an analog video signal and an analog audio signal to the encoder section 200. When a compressed digital video signal and digital audio signal are directly input, the encoder section 200 can supply the compressed digital video signal and digital audio signal directly to the formatter 204. Moreover, the encoder section 200 can supply digitized video signal and audio signal directly to a video mixing section 305 and an audio selector 301, respectively.

The video encoder included in the encoder section 200 converts a digital video signal into a digital video signal compressed at a variable bit rate conforming to the MPEG2 or MPEG1 standard. An audio signal is converted into a digital audio signal compressed at a fixed bit rate conforming to the MPEG or AC-3 standard or a linear PCM digital audio signal.

When a sub-video signal is input from the AV input section 211 (for example, a signal from a DVD video player with a sub-video signal independent output terminal) or when a DVD video signal with such a data-structure is broadcast and the TV tuner 212 receives the signal, the sub-video signal in the DVD video signal is encoded (or run-length encoded) at the sub-video encoder, which produces a sub-video bit map.

The encoded digital video signal, digital audio signal, and sub-video signal are packed at the formatter 204 into video packs, audio packs, and sub-video packs. Furthermore, these are gathered together and converted into a format determined in the DVD-recording standard (for example, the standard followed in recording data onto a DVD-RAM, DVD-R, or DVD-RW).

Here, in the apparatus, the information (including video packs, audio packs, and sub-video packs) formatted at the formatter 204 and the management information created at the formatter 204 can be supplied via the data processor section 103 to the hard disk drive section 104 or disk drive section 102, which enables data to be written onto the hard disk or optical disk 101. Moreover, the information recorded on a hard disk or an optical disk may be recorded onto the optical disk 101 or hard disk via the data processor 103 or disk drive section 102.

Furthermore, the video objects of a plurality of programs recorded on the hard disk or optical disk 101 may be edited by, for example, deleting a part of the video objects or connecting an object of a different program to the video objects. This is possible because a data unit dealt with by the DVD format has been defined and processing signals in the data unit makes editing easier.

The microcomputer block 400 includes an MPU (microprocessing unit) or a CPU (central processing unit), a ROM in which a control program and others have been written, and a RAM for providing a work area necessary to execute a program.

According to the control program stored in the ROM, the MPU of the microcomputer block 400 detects a defective place and an unrecorded area, sets a picture recording information recording position, records UDF, and sets an AV address by using the RAM as a work area.

Furthermore, the microcomputer 400, which has an information processing section necessary to control the entire system, includes a work RAM, a directory detecting section, a VMG (overall video management information) information creating section, a copy-related information detecting section, a copy and scrambling information processing section (or RDI processing section), a packet header processing section, a sequence header processing section, and an aspect ratio information processing section.

Of the results of the execution of the MPU, those to be notified to the user are displayed on a display section 402 of the video data recording and reproducing apparatus or on a monitor display in OSD (on-screen display) form. The microcomputer block 400 has a key input section 401 that supplies an operation signal for operating the apparatus. On the basis of time data from an STC (system time clock) 403, the microcomputer block 400 realizes the timing with which it controls the disk drive section 102, hard disk drive section 104, data processor section 103, and encoder section 200 and/or decoder section 300.

The operation of recording or reproducing is usually carried out in synchronization with the time clock from the STC 403. The other processes may be carried out with the timing independent of the STC 403.

The decoder 300 includes a separator that separates each pack from a pack-structure signal with the DVD-format, a memory used in separating packs and carrying out the other signal processing, a V decoder that decodes the main video data (or the contents of a video pack) separated at the separator, an SP decoder that decodes the sub-video data (or the contents of a sub-video pack) separated at the separator, and an A decoder that decodes the audio data (or the contents of an audio pack) separated at the separator. The decoder 30 further includes a video processor that combines the decoded main video with the decoded sub-video suitably and outputs the main video in such a manner that menus, highlight buttons, subtitles, and other sub-video are superimposed on the main video.

The output video signal of the decoder section 300 is input to the video mixing section 305. The video mixing section 305 composes text data. Connected to the video mixing section 305 are lines used to directly take in the signals from the TV tuner 212 and A/V input section 211. Further connected to the video mixing section 305 is a frame memory 306 used as a buffer. When the output of the video mixing section 305 is an analog output, it is output via an I/F (interface) 307 to the outside. When the output of the video mixing section 305 is a digital output, it is output via a digital-analog converter 308 to the outside.

Furthermore, the video mixing section 305 can output a video signal for making a guide screen (or a screen explained in FIG. 6 or 9) as a GUI. The video signal is controlled by a guide screen processing control section in the microcomputer block 400. Moreover, the video mixing section 305 further includes an operation input decision section 40a, a picture recording schedule control section 40b, an editing control section 40c, and a guide screen processing control section 40d. The control section 400 can supervise the entire apparatus.

In addition, the microcomputer block 400 includes a control block 40e for making the aforementioned “main-story automatic chapter division” and a control block 40f for making the “structural analysis chapter division”. A part of the silence detecting unit 25, silent time storage unit 26, silent portion interval computing unit 27, chapter boundary setting unit 28, and data processing section 24 correspond to the control block 40e for making the “main-story automatic chapter division”.

When FIG. 10 is compared with FIG. 1, the tuner 212 corresponds to the tuner 21, the encoder section 200 corresponds to the audio signal processing section 22, video signal processing section 29, and encoder section 23. The data processor 103 corresponds to the data processing section 24.

The output audio signal from the decoder section 300 is supplied via the selector 301 to the digital-analog converter 302, which converts the signal into analog signal and outputs the signal to the outside. The selector 301 is controlled by the select signal from the microcomputer block 400. This enables the selector 301 to directly select a signal passed through the encoder section 200 when the digital signal from the TV tuner 212 or A/V input section 211 is monitored directly.

The formatter of the encoder section 200 creates each piece of segment information (such as information on GOP begin interrupt time) during picture recording and sends them periodically to the MPU of the microcomputer block 400. Segment information includes the number of VOBU (video object unit) packs, the end address of an I picture from the beginning of a VOBU, and the reproducing time of a VOBU.

At the same time, information from the aspect information processing section is sent to the MPU at the start of picture recording. The MPU creates VOB stream information (STI). Here, STI holds resolution data, aspect data, and the like. In reproduction, each decoder section does initial setting on the basis of the information.

In the apparatus, one disk is allowed to have one video file. To continue reproduction without interruption while accessing (or seeking) data, a minimally contiguous information unit (size) has been determined. The unit is called a CDA (contiguous data area). The CDA size is a multiple of an ECC (error correction code) block (16 sectors). The file system records data in CDA units.

The data processor section 103 receives data in VOBU units from the formatter of the encoder section 200 and supplies data in CDA units to the disk drive section 102 or hard disk drive section 104. The MPU of the microcomputer block 400 creates management information necessary to reproduce the recorded data and, when recognizing a data recording end command, sends the created management information to the data processor section 103. Then, the management information is recorded onto the disk. Therefore, while encoding is being done, the MPU of the microcomputer block 400 receives information (including segment information) in data units from the encoder section 200. Furthermore, the MPU of the microcomputer block 400 recognizes the management information (file system) read from the optical disk or hard disk at the start of recording, then recognizes an unrecorded area on each disk, and sets the recording area of the data in the disk via the data processor section 103.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal delimiter information setting method of taking in an audio signal from an audio signal processing section and analyzing the state of the signal, in an apparatus for processing signals from a video signal processing section and the audio signal processing section, the method comprising:
determining a portion where the audio level is equal to or lower than a threshold value for a specific time in the audio signal to be a silent portion;
determining whether the time interval between the silent portion and the next silent portion is a multiple of a specific time (A);
if the time interval is a multiple of the specific time (A), counting the number of times a silent portion is detected; and
if the count of the silent portions is equal to or larger than a threshold value (B), setting delimiter information in the silent portion appearing at the beginning and the one appearing at the end.

2. The video signal delimiter information setting method using silent portions according to claim 1, wherein the specific time (A) is variable.

3. The video signal delimiter information setting method using silent portions according to claim 1, wherein the threshold value (B) has a margin.

4. The video signal delimiter information setting method using silent portions according to claim 1, wherein the delimiter information is used as chapter delimiter information.

5. The video signal delimiter information setting method using silent portions according to claim 2, wherein a video signal from the video signal processing section and the audio signal from the audio signal processing section are converted into signals with a format for recording onto a recording medium, and the delimiter information is included in management information recorded on the recording medium and is recorded onto the recording medium.

6. An video signal delimiter information setting apparatus for taking in an audio signal from an audio signal processing section and analyzing the state of the signal in an apparatus for processing signals from a video signal processing section and the audio signal processing section, the apparatus comprising:
a silence detecting unit which determines a portion where the audio level is equal to or lower than a threshold value for a specific time in the audio signal to be a silent portion;
a silent portion time interval measuring section which determines whether the time interval between the silent portion and the next silent portion is a multiple of a specific time (A);
a counting section which, if the time interval is a multiple of the specific time (A), counts the number of times a silent portion is detected; and
a silent portion condition decision section, if the count of the silent portions is equal to or larger than a threshold value (B), sets delimiter information in the silent portion appearing at the beginning and the one appearing at the end.

7. The video signal delimiter information setting apparatus using silent portions according to claim 6, further comprising a chapter boundary setting unit which sets a chapter boundary in a video signal from the video signal processing section on the basis of delimiter information from the silent portion condition decision section.

8. The video signal delimiter information setting apparatus using silent portions according to claim 6, further comprising a guide screen processing control section which outputs to a display an image including an item for setting the turning on or off of the function of creating the delimiter information.

9. The video signal delimiter information setting apparatus using silent portions according to claim 6, further comprising a guide screen processing control section which outputs to a display an image including an item for setting the turning on or off of the function of creating the delimiter information on the basis of the detection of a silent portion.

10. The video signal delimiter information setting apparatus using silent portions according to claim 6, further comprising a guide screen processing control section which outputs to a display an image including an item for setting the turning on or off of the function of creating the delimiter information on the basis of the detection of a similar shot.

11. The video signal delimiter information setting apparatus using silent portions according to claim 6, further comprising a guide screen processing control section which outputs to a display an image including the item “chapter division” for setting the function of forming chapter division points by a different method from a method of creating the delimiter information.
